(19) United States
(12) Patent Application Publication
(10) Pub. No.: US 2003/0212549 A1
(43) Pub. Date: Nov. 13, 2003

(54) Wireless communication using sound

(76) Inventors: Jack Steentra, San Diego, CA (US); Ahmad Jalali, San Diego, CA (US)

Correspondence Address: Qualcomm Incorporated, Patents Department, 5775 Morehouse Drive, San Diego, CA, 92121-1714, US

(21) Appl. No.: 10/356,144

(22) Filed: Jan. 30, 2003

Related U.S. Application Data
(60) Provisional application No. 60/379,867, filed on May 10, 2002.

(51) Int. Cl. G10L 19/00

(52) U.S. Cl. 704/201

(57) ABSTRACT

An apparatus and method for bidirectional communication using sound waves is disclosed. The invention uses a multi-carrier modulation scheme to transmit and receive digital data on acoustic waves. In one embodiment, acoustic waves having frequencies in the range between approximately 1 kHz to 3 kHz are used such that digital data can be transmitted by a standard speaker and microphone.

### RELATED APPLICATIONS

This application claims priority from U.S. Provisional Patent Application entitled “Wireless Communication Using Audio Tones,” Serial No. 60/379,867, filed May 10, 2002, which application is incorporated herein by reference in its entirety.

### BACKGROUND OF THE INVENTION

I. Field of Invention

The invention generally relates to wireless communications, and more particularly to wireless communications using acoustic waves.

II. Description of the Related Art

Advances in communication technology have made it easier and faster to share and/or transfer information. High volumes of data can be communicated through data transmission systems such as a local or wide area network (for example, the Internet), a terrestrial communication system or a satellite communication system.

These systems require complicated hardware and/or software and are designed for high data rates and/or long transmission ranges. For transfers of data at close proximity or short distances, such as between a personal computer and personal data assistants (PDAs), the systems above may be an inconvenient communication medium for users because of the complexity, delay and often the cost involved in accessing the systems.

Accordingly, other communication systems have been developed using communication medium such as radio frequency (RF) or Infrared (IR) to transmit data. However, these systems require specialized communication hardware and/or interfaces, which can often be expensive and/or impractical to implement. Non-wireless connections can also be used to transfer data. However, to use non-wireless types of connections, users must physically have as well as carry wires or cables and make the physical connections for communication. This can be burdensome and inconvenient to users.

Therefore, there is need for a less complex, yet user-friendly, inexpensive and/or efficient way to share and/or transfer information.

### SUMMARY

A communication system uses sound to transmit and/or receive digital data.

At a transmitting device, digital data is encoded into sound signals carried on sound waves having a certain frequency or range of frequencies. At a receiver device, the sound waves are received and decoded back into digital data.

In one embodiment, an apparatus and method for transmitting digital data comprises means for generating sound and modulation means for encoding the digital data into sound waves for transmission through the means for generating sound. The apparatus further comprises storage means for storing data to be transmitted. The modulation means may be implemented by a multi-carrier (MC) modulation means for encoding the digital data into multiple sound wave carriers. The encoding by the MC modulation means may comprise forward error correction, interleaving and modulation. The modulation may comprise converting the interleaved bit sequence into QPSK symbols, converting the QPSK symbols into time-domain representations, and up-converting the time domain representations to the appropriate sound wave carriers.

In another embodiment, an apparatus and method for receiving digital data comprises means for receiving sound waves encoded with digital data and demodulation means to recover the digital data from the sound waves. The means for receiving may receive multiple sound wave carriers encoded with digital data and the demodulation means may be implemented by a MC demodulation means for recovering the digital data from the multiple sound wave carriers. The recovery of digital data may comprise demodulation, de-interleaving and decoding. Also, the recovery of digital data may further comprise estimating channel noise and normalizing the multiple sound wave carriers using the estimated channel noise before demodulating the symbols from the multiple sound wave carriers.

In still another embodiment, an apparatus comprises a speaker and a microphone to communicate digital data using sound.

In a further embodiment, a machine readable medium for digital data communication comprises a first set of code segments for forward error correction encoding bit sequence of digital data, a second set of code segments for interleaving the encoded bit sequence, and a third set of code segments for modulating the interleaved bit sequence into sound waves. Also, the machine readable medium may further comprises a fourth set of code segments for demodulating symbols from received sound waves, a fifth set of code segments for de-interleaving the demodulated symbols, and a sixth set of code segments for decoding the de-interleaved symbols to recover digital data. The third set of code segments may comprises code segments for modulating the interleaved bit sequence into multiple sound wave carriers and the fourth set of code segments may comprise code segments for demodulating symbols from multiple sound wave carriers.

### BRIEF DESCRIPTION OF THE DRAWINGS

In the following drawings, like reference numerals refer to like elements, wherein:

FIG. 1 shows examples of data transmission;

FIG. 2 shows one embodiment of a system for transmitting and/or receiving data on sound waves;

FIG. 3 shows one embodiment of a multi-carrier modulator;

FIG. 4 is a flowchart of a procedure for transmitting data on sound waves;

FIG. 5 shows a mapping of bits onto in-phase and quadrature coordinates;

FIG. 6 shows one embodiment of a multi-carrier demodulator; and

FIG. 7 shows one embodiment of a device implementing the system for transmitting and/or receiving data on sound waves.

### DETAILED DESCRIPTION

Generally, acoustic channels are provided to allow wireless transfer of digital data using sound. Many devices and/or computers have either built-in microphones and speakers, or add-in sound cards for processing audio data. The primary reason for these interfaces has been to record and playback audio signals such as music and/or speech. These interfaces have not been used for transmission of digital data.

Particularly, because there can be large amounts of interference and/or noise in the acoustic channel, it is difficult or nearly impossible to use acoustic signals for reliable and/or accurate transmission of digital data. Moreover, due to the slow speed of acoustic signals as compared to the speed of light, the acoustic signals also suffer from degradations caused by multipath signals, even at relatively short distances. Therefore, in order to combat frequency selective fading caused by multipath and frequency selective interference caused by narrowband jammers, a multi-carrier modulation scheme is proposed for digital data transmission over acoustic channels.

As disclosed herein, the term “acoustic channel” refers to a path of communication by the use of sound between two or more points. The term “sound wave” refers to acoustic wave or pressure waves or vibrations traveling through gas, liquid or solid. Sound waves include ultrasonic, audio and infrasonic waves. The term “audio wave” refers to sound wave frequencies lying within the audible spectrum, which is approximately 20 Hz to 20 kHz. The term “ultrasonic wave” refers to sound wave frequencies lying above the audible spectrum and the term “infrasonic wave” refers to sound wave frequencies lying below the audible spectrum. The term “storage medium” represents one or more devices for storing data, including read only memory (ROM), random access memory (RAM), magnetic disk storage mediums, optical storage mediums, flash memory devices and/of other machine readable mediums. The term “machine readable medium” includes, but is not limited to portable or fixed storage devices, optical storage devices, and various other devices capable of storing instruction and/or data. The term “tone” refers to sound wave(s) of certain pitch and vibration that carry digital data. The term “multiple sound wave carriers” refers to the carrier signals in a multi-carrier system where multiple sound waves are used as the carrier signals.

Also, various aspects, features and embodiments of the data communication system may be described as a process that can be depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a software, a subroutine, a subprogram, or a combination thereof.

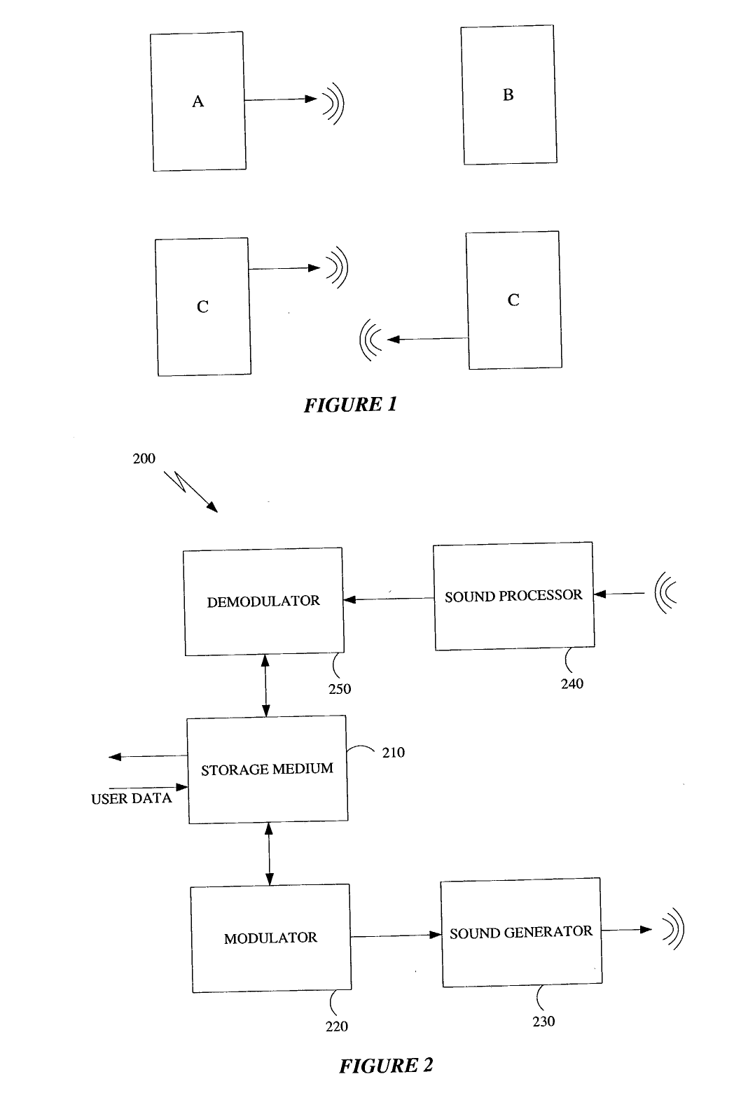

As shown in FIG. 1, digital data communication using sound waves may be in one direction or bi-directional between two devices. Device A may be an electronic apparatus implemented with at least a sound generator and an input element for receiving user input and/or programmed input. Device B may be an electronic apparatus implemented with at least a sound processor. Device C may be an electronic apparatus implemented with at least a sound generator, a sound processor and an input element. Examples of Devices A, B or C include, but are not limited to, computers such as laptops and desktops, personal data assistants (PDAs), mobile phones, telephones, answering machines, pagers, electronic appliances, electronic gaming consoles, electronic toys, televisions, remote controls, remotely operable devices or a combination thereof. Generally, a multi-carrier system is used to transmit digital data as sound through a sound generator and to receive the digital data as sound through a sound processor. In one embodiment, sound waves that represent digital data have frequencies that correspond to audio waves. More particularly, audio waves having frequencies in the range from about 1 kHz to 3 kHz are used to communicate digital data.

FIG. 2 shows one embodiment of a data communication system 200 used to transmit and receive digital data on multiple sound wave carriers. In one embodiment, the data communication system 200 transmits and receives digital information including digital text, image and/or audio data on multiple sound wave carriers. System 200 may comprise a storage medium 210 configured to store digital data information to be transmitted and/or presented, a modulator 220 configured to encode digital data from storage medium 210 into outgoing sound waves for transmission, a sound generator 230 configured to emit the outgoing sound waves, a sound processor 240 configured to receive incoming sound waves, and a demodulator 250 configured to recover the digital data from the incoming sound waves. In one embodiment, modulator 220 is a multi-carrier (MC) modulator configured to encode digital data into outgoing multiple sound wave carriers for transmission and demodulator 250 is a MC demodulator configured to recover the digital data from the incoming multiple sound wave carriers. While other modulation schemes may be used, for purposes of explanation multi-carrier modulation will be used to describe the embodiments.

The recovered digital data may be output to a user through a display and/or other output devices for presentation, or may be stored for later presentation or use. The digital data may be, but is not limited to, personal information; contact information such as names, phone numbers, and addresses; business information; calendar information; memos; software or a combination thereof. System 200 may also comprise a processor (not shown) such as a central processor (CPU) or digital signal processor (DSP) to control the transmission and reception of data using sound waves. It would be apparent to those skilled in the art that the placement of the processor is not important and that the placements of elements 210-250 may also be rearranged without affecting the performance and/or purpose of system 200.

Sound generator 230 may comprise at least an audio output element such as a speaker, a sound card or other apparatus capable of generating sound. Sound processor 240 may comprise at least an audio input element such as a microphone, a sound card or other apparatus capable of receiving and/or processing sound. Here, sound generator 230 and sound processor 240 may be implemented in one apparatus such as, for example, a sound card, circuit or module. In addition, there may be more than one storage medium 210 for separately storing data information to be transmitted and data information to be presented or displayed. Furthermore, storage medium 210, modulator 220, sound generator 230, sound processor 240 and demodulator 250 may be implemented on one or more circuit card assemblies. Such circuit card assemblies may be installed in a self-contained enclosure that mounts on or adjacent to existing hardware on Device A, B or C. For example, Device A may comprise storage medium 210, modulator 220 and sound generator 230 for transmitting data using sound waves, while Device B may comprise storage medium 210, sound processor 240 and demodulator 250 for receiving data using sound waves. Moreover, in another embodiment, one or more of storage medium 210, modulator 220, sound generator 230, sound processor 240 and demodulator 250 may be implemented by hardware, software, firmware or a combination thereof. For example, a storage medium may store instructions to encode data into multiple sound wave carriers and to recover data from multiple sound wave carriers.

In one embodiment, audio waves are used as the multi-carrier signals for digital data communication. For example, audio waves having frequencies in the range of approximately 1 kHz to 3 kHz are used such that a standard speaker and/or microphone can be used to generate, receive and/or process sound. However, the digital data communication system as described above is not limited to audio waves, but may be implemented by other sound wave frequencies including ultrasonic and infrasonic waves. Moreover, particular tones may be selected such that the sound wave carriers can be transmitted over a plain old telephone service (POTS).

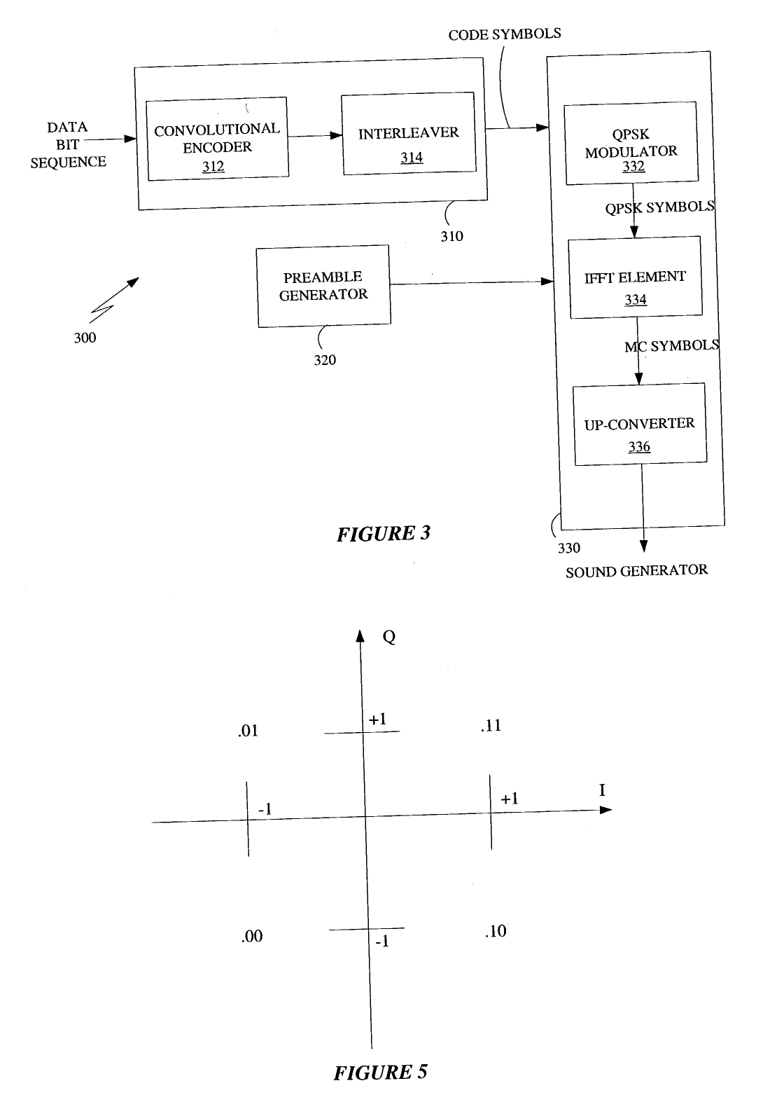

FIG. 3 shows one embodiment of a MC modulator 300 for encoding digital data into outgoing multiple sound wave carriers for transmission. MC modulator 300 may comprise a front end processor 310, a preamble generator 320 and a modulator 330.

Front end processor 310 receives and encodes digital data to generate code symbols. The encoding may include error correction coding and/or error detection coding to increase the reliability of the acoustic channel. Such encoding may include, but is not limited to, interleaving, convolutional coding, and cyclic redundancy check (CRC) coding. Addition of CRC bits is a known technique to allow error detection.

In one embodiment, the front end processor 310 comprises a forward error correction (FEC) element 312 to encode digital data bit sequence to be transmitted and an interleaver 314 to interleave the FEC encoded bits. The interleaved bits are the generated code symbols. Here, FEC encoding is a known technique that enables a receiver to detect errors.

Preamble generator 320 generates synchronization preambles. The synchronization preambles are transmitted to help the receiver in synchronizing to the frequency, time and phase of the received signal.

Modulator 330 modulates the code symbols into multiple sound wave carriers.

In one embodiment, modulator 330 may comprise a digital modulator 332, an inverse fast fourier transform (IFFT) element 334 and an up-converter 336 for modulation of the code symbols into multiple sound wave carriers. Digital modulator 332 may be a quadrature phase shift keying (QPSK) modulator. However, a digital modulation technique other than QPSK such as for example, amplitude shift keying (ASK), frequency shift keying (FSK), phase shift keying (PSK) or a combination thereof, can be implemented in modulator 330.

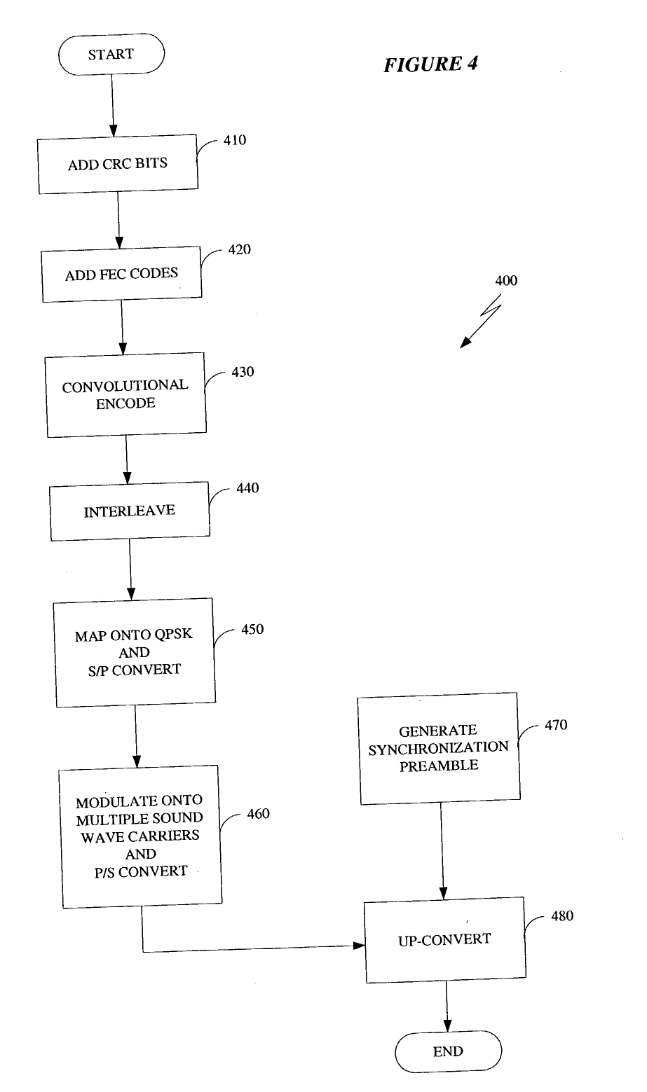

FIG. 4 is one embodiment of a process 400 for encoding digital data information onto sound waves for transmission. When digital data is to be transmitted, FEC codes may be added to the end of the data bit sequence (420). Also, digital data to be transmitted may be information pre-stored in a storage medium or may be newly input information for purposes of transmission. In one embodiment, FEC encoding comprises adding CRC bits to the end of digital data bit sequence. The FEC encoding may further comprise convolutionally encoding digital data to be transmitted. For example, K number of zero tail bits equal to the size of a convolutional encoder memory are added to the end of the digital data sequence. The resulting digital data sequence is then encoded.

The FEC encoded bits are then interleaved into code symbols (440). In one embodiment, the interleaver may be a block interleaver where the FEC encoded bits are written column-wise into a matrix M×N and read out row-wise. Here, the size of the matrix M×N is equal to the total number of encoded bits. Also, the number of rows is chosen to be larger than the constraint length of the code symbol.

The code symbols are modulated into multiple sound wave carriers (450) and converted from serial to parallel (S/P). In one embodiment, the code symbols are mapped into QPSK symbols and converted from S/P to produce N QPSK symbols.

QPSK is a known technique of constant-amplitude digital modulation. Generally, the code symbols are divided into groups of 2 bits where the first bit is modulated on the in-phase (I) channel and the second bit on the (quadrature) Q channel. The 0 bits and 1 bits are mapped to 1 and −1 respectively as shown in FIG. 5. After mapping onto the I and Q channels, each b₀b₁ pair is represented by a complex number aᵢ+ja_{q} called QPSK symbol. The N QPSK symbols are inverse fast fourier transformed and converted from parallel to serial (P/S) to generate analog symbols hereafter called MC symbols (460).

Here, N is the number of tones in a multiple sound wave carrier system and is also the size of the IFFT that will be used to generate the MC symbol. The sequence of QPSK symbols aᵢ+ja_{q} are divided into groups of N symbols which correspond to the S/P converted symbols in modulator 330. The block of N QPSK symbols are then sent to the IFFT to generate the MC symbols and the generated MC symbols are converted from P/S for modulation by up-converter 336. In one embodiment, the multi-carrier signals have frequencies in the range from about 1 kHz to 3 kHz. In such case, N carriers are modulated in the frequency band of about 1 kHz to 3 kHz for a total bandwidth of about 2 kHz. Also, in one embodiment, the number of tones used is 64, and a total bandwidth of about 2 kHz would allow about 31.25 Hz of bandwidth for each carrier. Note that the above ranges and numbers are examples. Accordingly, other frequency ranges of greater or shorter bandwidth and/or number of tones may be used.

Also, in order to synchronize to signals received through an acoustic channel, synchronization preambles are generated (470). Typically, timing reference preambles, frequency reference preambles and phase reference preambles are generated as the synchronization preambles and are sent to provide timing, frequency and phase references for the MC symbols that carry digital data information. In one embodiment, a differential QPSK (DQPSK) modulator is implemented such that one phase reference preamble is required for the MC symbols. In DQPSK, the phase generated as shown in FIG. 5 for the newly arrived pair of bits b₀b₁ is added to the phase of the previous symbol for each tone, and the resulting phase is modulated onto the tone of the MC symbol being generated.

The MC symbols and the synchronization preambles are up-converted into the appropriate multiple sound wave carriers (480).

Accordingly, digital data may be modulated into multiple sound wave carrier signals for transmission and emitted as sound waves through sound generator 230. In one embodiment, the MC symbols are transmitted at the end of the preamble transmission. Since sound is used as the communication channel, Device B or C within the distance over which sound can be heard, detected or sensed can receive and process the transmission through sound processor 240 and MC demodulator 250 for display, storage and/or presentation. Due to the nature of the acoustic channel, the amount of interference rises as the distance increases between two communicating devices.

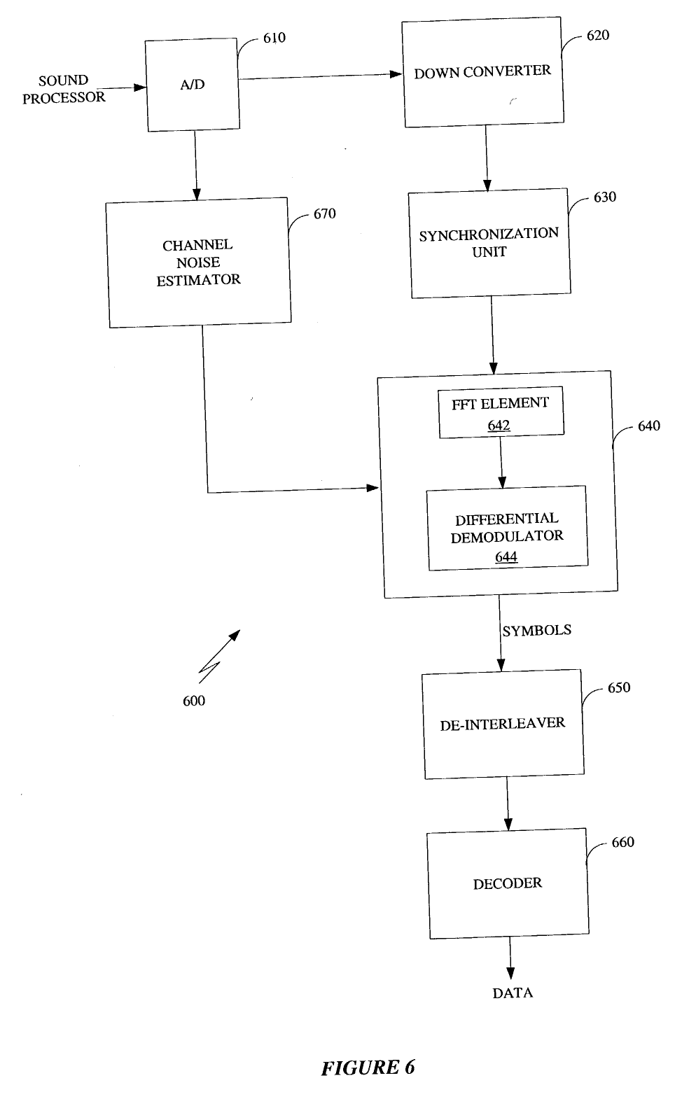

FIG. 6 shows one embodiment of a MC demodulator 600 for processing multiple sound wave carriers encoded with digital data information. Generally, digital data is recovered from the multiple sound wave carriers in a process that is inverse to the process for transmitting the data as sound waves. MC demodulator 600 may comprise an analog to digital (AID) converter 610 to convert the incoming multiple sound wave carriers from an analog to a digital signal, a down-converter 620, a synchronization unit 630 to synchronize to the carrier in phase and arrival time of incoming data sequence, a demodulator 640 to demodulate and recover digital data from the multiple sound wave carriers by filtering out the carrier signals, a de-interleaver 650 to de-interleave the demodulated data, and a decoder 660 to decode the de-interleaved data for output to a user. MC demodulator 600 may further comprise a channel noise estimator 670 to estimate the noise level in the acoustic channel.

Upon A/D conversion and down conversion, synchronization unit 630 uses the synchronization preambles sent with the MC symbols to synchronize the acoustic channel. Namely, the timing, frequency and phase references for the MC symbols are obtained from the synchronization preambles and used for synchronization. The synchronization preambles are then discarded and the remaining MC symbols are demodulated by demodulator 640.

In one embodiment, corresponding to MC modulator 300, demodulator 640 may comprise a FFT 642 to recover the MC symbols and a differential demodulator 644 to demodulate the MC symbols. As in the transmitter side, it is to be noted that a digital demodulation corresponding to a digital modulation other than QPSK can be implemented in demodulator 640. For example, coherent modulation/demodulation may be used, in which case the phase of the received signal is estimated at the receiver and used to demodulate the desired information.

Channel noise estimator 670, if implemented, computes a power spectral density of the interference samples received prior to the arrival of the synchronization preamble information. Namely, output samples from A/D converter 610 are maintained in a storage medium prior to the detection of the correlation information. Because these samples contain interference, the power spectral density of the interference or noise level can be estimated using known techniques. For example, in demodulator 640, the power spectral density is used to normalize the received signal on each tone by the interference/noise power on that tone prior to decoding. Such normalization may null out any tones that are impacted by a large amount of interference. Once the power spectral density of the interference/noise is known, techniques other than normalization may also be used to null out the effect of tone with high interference/noise. This is important in the acoustic channel where there may effectively be jammers at certain portions within the spectrum.

Also in one embodiment, decoder 660 may comprise a Viterbi decoder. Thus, the deinterleaved data is decoded using well known implementations of the Viterbi algorithm. The decoded digital data can be displayed or stored for later use.

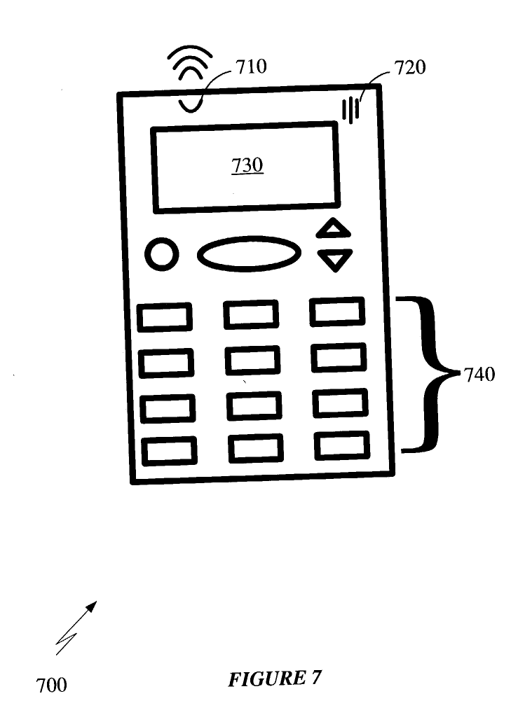

FIG. 7 shows one embodiment of a process 700 for recovering digital data information from sound waves. When multiple sound wave carriers are received, the incoming multiple sound wave carriers are A/D converted into digital signals (710) and down-converted (720). Upon A/D conversion and down conversion, the digital signals are synchronized using the synchronization preambles sent with the MC symbols (730). In one embodiment, the noise in the acoustic channel is estimated (740). Here, the power spectral density of the interference or noise level can be estimated by computing the power spectral density of samples received prior to the arrival of the synchronization preamble information.

The synchronization preambles are then discarded and the remaining MC symbols are demodulated (750), in view of the estimated channel noise if available. If channel noise estimation is available, signals received on a corresponding sound wave carrier is normalized before demodulation. The demodulation may comprise using a FFT to recover the MC symbols and a differential demodulation to demodulate the MC symbols. The demodulated MC symbols are then decoded (760). In one embodiment, the decoding comprises deinterleaving and decoding according to the Viterbi algorithm.

As described above, the digital data information may be demodulated from multiple sound wave carrier signals received through sound processor 240.

FIG. 8 shows one embodiment of a portable apparatus for transmitting and receiving data on sound waves. Apparatus 800 comprises a sound generator 810, a sound processor 820, an output element 830 and an input element 840. As discussed above, sound generator 810 may be an audio output such as a speaker and/or sound card and sound processor 820 may be an audio input such as a microphone (mic) and/or a sound card. Output element 830 may be, but is not limited to, a display and input element 240 may be, but is not limited to, a keypad, a keyboard, a mouse and/or a touch screen. When a user wishes to communicate data to another user or device, the user can input new data or retrieve pre-stored data through input element 840 and transmit the data as digital data on sound waves through sound generator 810. When a user wishes to receive data from another user or device, sound processor 820 can receive sound waves encoded with digital data. The data can then be recovered, stored and/or displayed to the user through output element 830.

For example, a speaker transmits outgoing multiple sound wave carriers encoded with first digital data and a microphone configured to receive incoming multiple sound wave carriers encoded with second digital data. As discussed above, the outgoing and incoming multiple sound wave carriers may have frequencies in a range that corresponds to audio waves. More particularly, the outgoing and incoming multiple sound wave carriers may have frequencies in a range from about 1 kHz to 3 kHz. In addition, the first and second digital data may be encoded into tones that can be transmitted and received through POTS.

Accordingly, users can easily and conveniently perform a one way or bidirectional communication as described above. By using a multi-carrier system, data can be transmitted in a robust manner using sound waves. Furthermore, a standard speaker and/or microphone can be used to implement the invention. Therefore, the invention can easily be implemented in existing devices since most computers have either built-in speakers and microphones or add-in sound cards, modules, devices or interfaces.

In addition, embodiments may be implemented by hardware, software, firmware, middleware, microcode, or any combination thereof. When implemented in software, firmware, middleware or microcode, the program code or code segments to perform the necessary tasks may be stored in a machine readable medium such as storage medium 210 or in a separate storage(s) not shown. A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The foregoing embodiments are merely exemplary and are not to be construed as limiting the invention. The present teachings can be readily applied to other types of apparatuses. The description of the embodiments is intended to be illustrative, and not to limit the scope of the claims. Many alternatives, modifications, and variations will be apparent to those skilled in the art.

What is claimed is:

1. Apparatus for transmitting digital data, comprising:
a sound generator;
a storage medium coupled to the sound generator, the storage medium configured to store digital data; and
a modulator coupled to the sound generator and the storage medium, the modulator configured to encode the digital data into sound waves for transmission through the sound generator.

2. The apparatus of claim 1, wherein the sound generator comprises an audio output element.

3. The apparatus of claim 1, wherein the modulator comprises:
a multi-carrier (MC) modulator configured to encode the digital data into multiple sound wave carriers for transmission through the sound generator.

4. The apparatus of claim 3, wherein the multiple sound wave carriers have frequencies a range that corresponds to audio waves.

5. The apparatus of claim 3, wherein the multiple sound wave carriers have frequencies in a range from about 1 kHz to 3 kHz.

6. The apparatus of claim 3, wherein the MC modulator comprises:
a forward error correction (FEC) element to encode bit sequence of the digital data;
an interleaver coupled to the FEC element and configured to interleave the encoded bit sequence; and
a modulator couple to the interleaver and configured to modulate the interleaved bit sequence into the multiple sound wave carriers.

7. The apparatus of claim 6, wherein the FEC element comprises:
a convolutional encoder configured to convoluationally encode the bit sequence of the digital data.

8. The apparatus of claim 7, wherein the modulator comprises:
a quadrature phase shift keying (QPSK) element configured to convert the interleaved bit sequence into QPSK symbols;
an inverse fast fourier transform (IFFT) element coupled to the QPSK modulator and configured to IFFT the QPSK symbols; and
an up-converter coupled to the IFFT element and configured to modulate the IFFT symbols into the multiple sound wave carriers.

9. The apparatus of claim 8, wherein the QPSK modulator is a differential QPSK modulator.

10. A method of transmitting digital data, comprising:
storing digital data; and
encoding the digital data into sound waves for transmission.

11. The method of claim 10, wherein encoding the digital data comprises encoding the digital data into multiple sound wave carriers.

12. The method of claim 11, wherein encoding comprises encoding the digital data into multiple sound wave carriers having frequencies in a range that corresponds to audio waves.

13. The method of claim 11, wherein encoding comprises encoding the digital data into multiple sound wave carriers having frequencies in a range from about 1 kHz to 3 kHz.

14. The method of claim 11, wherein encoding comprises encoding the digital data into tones that can be transmitted through a plain old telephone system.

15. The method of claim 11, wherein encoding the digital data comprises:
forward error correction encoding bit sequence of the digital data to be transmitted;
interleaving the encoded bit sequence; and
modulating the interleaved bit sequence into the multiple sound wave carriers.

16. The method of claim 15, wherein the forward error correction encoding comprises:
convolutionally encoding the bit sequence of data to be transmitted.

17. The method of claim 15, wherein the forward error correction encoding comprises:
adding cyclic redundancy check bits to the end of the bit sequence of digital data to be transmitted.

18. The method of claim 15, wherein the modulating comprises:
mapping the interleaved bit sequence onto quadrature phase shift keying (QPSK) carriers;
inverse fast fourier transforming the QPSK modulated bit sequence; and
up-converting the inverse fast fourier transformed bit sequence into the multiple sound wave carriers.

19. The method of claim 18, wherein the mapping comprises mapping the interleaved data onto differential QPSK carriers.

20. Apparatus for receiving digital data, comprising:
a sound processor configured to receive sound waves encoded with digital data; and
a demodulator coupled to the sound processor and configured to recover the digital data from the sound waves.

21. The apparatus of claim 20, wherein the sound processor comprises an audio input element.

22. The apparatus of claim 20, wherein the sound processor is configured to receive multiple sound wave carriers encoded with digital data and the demodulator comprises:
a multiple carrier (MC) demodulator configured to recover the digital data from the multiple sound wave carriers.

23. The apparatus of claim 22, wherein the multiple sound wave carriers have frequencies in a range that corresponds to audio waves.

24. The apparatus of claim 22, wherein the multiple sound wave carriers have frequencies in a range from about 1 kHz to 3 kHz.

25. The apparatus of claim 22, wherein the MC demodulator comprises:
a demodulator configured to demodulate symbols from the multiple sound wave carriers;
a de-interleaver coupled to the demodulator and configured to de-interleave the demodulated symbols; and
a decoder coupled to the de-interleaver and configured to decode the deinterleaved symbols to recover the digital data.

26. The apparatus of claim 25, wherein the MC demodulator further comprises:
a channel noise estimator to normalize received signals on the multiple sound wave carriers before decoding the digital data.

27. The apparatus of claim 25, wherein the decoder comprises a Viterbi decoder.

28. The apparatus of claim 20, further comprising a display element configured to display the recovered digital data.

29. A method for receiving digital data, comprising:
receiving sound waves encoded with digital data; and
recovering the digital data from the sound waves.

30. The method of claim 29, wherein receiving the sound waves comprises receiving multiple sound wave carriers encoded with digital data and recovering the digital data comprises recovering the digital data from the multiple sound wave carriers.

31. The method of claim 30, wherein the multiple sound wave carriers have frequencies in a range that corresponds to audio waves.

32. The method of claim 30, wherein the multiple sound wave carriers have frequencies in a range from about 1 kHz to 3 kHz.

33. The method of claim 30, wherein recovering the data comprises:
demodulating symbols from the multiple sound wave carriers;
de-interleaving the demodulated symbols; and
decoding the de-interleaved symbols to recover the digital data.

34. The method of claim 33, further comprising:
estimating channel noise; and
normalizing received signals on the multiple sound wave carriers by the estimated channel noise before the decoding.

35. Apparatus for digital data communication, comprising:
a speaker configured to transmit outgoing multiple sound wave carriers encoded with first digital data; and
a microphone configured to receive incoming multiple sound wave carriers encoded with second digital data.

36. The apparatus of claim 35, wherein the outgoing and incoming multiple sound wave carriers have frequencies in a range that corresponds to audio waves.

37. The apparatus of claim 35, wherein the outgoing and incoming multiple sound wave carriers have frequencies in a range from about 1 kHz to 3 kHz.

38. The apparatus of claim 35, wherein the first and second digital data are encoded into tones that can be transmitted and received through a plain old telephone system.

39. Apparatus for transmitting digital data, comprising:
means for generating sound;
storage means to store digital data to be transmitted; and
modulation means for encoding the digital data into sound waves for transmission through the means for generating sound.

40. The apparatus of claim 39, wherein the modulation means comprises:
multi-carrier (MC) modulation means for encoding the digital data into multiple sound wave carriers.

41. The apparatus of claim 40, wherein the multiple sound wave carriers have frequencies in a range that corresponds to audio waves.

42. The apparatus of claim 40, wherein the multiple sound wave carriers have frequencies in a range from about 1 kHz to 3 kHz.

43. Apparatus for receiving digital data, comprising:
means for receiving sound waves encoded with digital data; and
demodulation means to recover the digital data from the sound waves.

44. The apparatus of claim 43, wherein the means for receiving sound waves comprises means for receiving multiple sound wave carriers encoded with digital data; and the demodulation means comprises multiple carrier (MC) demodulation means to recover the digital data from the multiple sound wave carriers.

45. The apparatus of claim 44, wherein the multiple sound wave carriers have frequencies in a range that corresponds to audio waves.

46. The apparatus of claim 44, wherein the multiple sound wave carriers have frequencies in a range from about 1 kHz to 3 kHz.

47. Machine readable medium for digital data communication comprising:
a first set of code segments for encoding bit sequence of digital data;
a second set of code segments for interleaving the encoded bit sequence; and
a third set of code segments for modulating the interleaved bit sequence into sound waves for transmission.

48. The medium of claim 47, wherein the third set of code segments comprises:
code segments for modulating the interleaved bit sequence into multiple sound wave carriers.

49. The medium of claim 48, wherein the third set of code segments comprises code segments for modulating the interleaved data into sound wave carriers having frequencies in a range that corresponds to audio waves.

50. The medium of claim 48, wherein the third set of code segments comprises code segments for forward error correction encoding the bit sequence of digital data.

51. The medium of claim 48, further comprising:
a fourth set of code segments for demodulating symbols from received multiple sound wave carriers;
a fifth set of code segments for de-interleaving the demodulated symbols; and
a sixth set of code segments for decoding the de-interleaved symbols to recover the digital data.
